(19) United States
(12) Patent Application Publication
(10) Pub. No.: US 2025/0174766 A1
(43) Pub. Date: May 29, 2025

(54) BATTERY SYSTEM

(71) Applicant: SAMSUNG SDI CO., LTD., Yongin-si (KR)

(72) Inventor: Eymen IPEK, Graz (AT)

(21) Appl. No.: 18/830,025

(22) Filed: Sep. 10, 2024

(30) Foreign Application Priority Data
Nov. 29, 2023 (EP) 23213125.0

(51) Int. Cl. H01M 10/6571; H01M 10/615; H01M 10/6551; H01M 10/6552; H01M 10/6568

(52) U.S. Cl. CPC H01M 10/6571; H01M 10/615; H01M 10/6551; H01M 10/6552; H01M 10/6568

(57) ABSTRACT

The present disclosure refers to a battery system. The battery system includes battery cells in a housing, a cooling circuit including a coolant channel for allowing a coolant to flow therethrough to be in thermal contact with at least a portion of the battery cells, an eddy current heater configured to heat a ferrous material by inducing eddy currents in the ferrous material, and to transfer heat to the coolant in the coolant channel, the ferrous material being inside at least a portion of the coolant channel or surrounding at least a portion of the coolant channel.

### CROSS-REFERENCE TO RELATED APPLICATION

The present application claims priority to and the benefit of European Patent Application No. 23213125.0, filed on Nov. 29, 2023, in the European Patent Office, the entire disclosure of which is incorporated herein by reference.

### BACKGROUND

### 1. Field

The present disclosure relates to a battery system with a coolant circuit. The present disclosure further deals with a vehicle including the battery system. In one or more embodiments, the present disclosure refers to a method of heating battery cells of a battery system.

### 2. Description of Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries, or may be a hybrid vehicle powered by, for example, a gasoline generator or a hydrogen fuel power cell. A hybrid vehicle may include a combination of an electric motor and conventional combustion engine.

Generally, an electric-vehicle battery (EVB, or traction battery) is a battery used to power the propulsion of battery electric vehicles (BEVs). Electric-vehicle batteries differ from starting, lighting, and ignition batteries, in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Battery modules can be constructed either in a block design or in a modular design. In the block design, each battery is coupled to a common current collector structure, and a common battery management system and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

To provide thermal control of the battery pack, a thermal management system may be desired to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the at least one battery module may no longer generate a desired (or designed) amount of power. In one or more embodiments, an increase of the internal temperature can lead to abnormal reactions occurring therein, and thus charging and discharging performance of the rechargeable battery may deteriorate, and the lifespan of the rechargeable battery may be shortened. Thus, cell cooling for effectively dissipating heat from the battery cells may be desired.

A battery system may include a cooling circuit for thermal management. The battery system (e.g., for automotive applications) is sensitive to environmental conditions (e.g., temperature). Low temperatures of the battery cells (e.g., during charging) may lead to weak performance and reduced lifetime.

Therefore, a pre-heating of the battery may be desirable to provide better performance (e.g., during charging and extend lifetime).

Despite that an electrical current flow can increase a temperature of a battery, even with this additional heat, charging at cold temperatures still remains a critical problem. An additional heater may be desired to allow reliable pre-heating of the battery.

Resistance heaters including a resistor with a voltage applied thereto may be used either as foils between the cells, or may be attached on the outside of a cooling plate. In such configuration, heat may be transferred from the resistance heaters to a coolant via the material of the cooling plate. However, this may be a slow form of heating that involves a lag time to reach a sufficient and desired temperature.

In establishing an improved heating concept including rapid heating, it may be of further significance to ensure that a heater modification avoids unnecessary leakage of coolant from the coolant channel through which the coolant is conducted. Furthermore, the coolant flow through the coolant channel should not be affected strongly. Additional problems become apparent in the following disclosure.

### SUMMARY

The present disclosure is defined by the appended claims, with functional equivalents thereof to be included therein. The description that follows is subjected to this limitation. Any disclosure lying outside the scope of said claims is only intended for illustrative or comparative purposes.

According to an aspect of the present disclosure, there is provided a battery system including battery cells in a housing, a cooling circuit including a coolant channel for allowing a coolant to flow therethrough to be in thermal contact with at least a portion of the battery cells, an eddy current heater configured to heat a ferrous material by inducing eddy currents in the ferrous material, and to transfer heat to the coolant in the coolant channel, the ferrous material being inside at least a portion of the coolant channel or surrounding at least a portion of the coolant channel.

The ferrous material may include an inner ferrous coating attached to at least a portion of an inner surface of the coolant channel.

The ferrous material may include at least one inner ferrous hollow body inside the coolant channel to cover an inner surface of the coolant channel.

The inner ferrous hollow body may include at least one of an inner hollow cylinder and an inner ring.

The ferrous material may include a flat inner surface.

The ferrous material may include a corrugated inner surface.

The corrugated inner surface may include ridges.

The ferrous material may include an outer ferrous coating attached to at least a portion of an outer surface of the coolant channel.

The ferrous material may include at least one outer ferrous hollow body surrounding at least a portion of the coolant channel to cover an outer surface of the coolant channel.

The ferrous material may be at a coolant inlet of the coolant channel at a periphery of the housing, or may extend from the coolant inlet along the coolant channel.

The ferrous material may be at a coolant outlet of the coolant channel at the periphery of the housing, or may extend to the coolant outlet along the coolant channel.

The coolant channel may include a non-ferrous material.

The eddy current heater may include a heating coil, and a charging circuit connected with the heating coil through AC power lines for inducing the eddy currents in the ferrous material.

According to another aspect of the present disclosure, there is provided a vehicle including a battery system including battery cells in a housing, a cooling circuit including a coolant channel for allowing a coolant to flow therethrough to be in thermal contact with at least a portion of the battery cells, an eddy current heater configured to heat a ferrous material by inducing eddy currents in the ferrous material, and to transfer heat to the coolant in the coolant channel, the ferrous material being inside at least a portion of the coolant channel or surrounding at least a portion of the coolant channel.

According to another aspect of the present disclosure, there is provided a method of heating battery cells of a battery system, the method including providing the battery system, the battery system including battery cells in a housing, a cooling circuit including a coolant channel for allowing a coolant to flow therethrough to be in thermal contact with at least a portion of the battery cells, an eddy current heater configured to heat a ferrous material by inducing eddy currents in the ferrous material, and to transfer heat to the coolant in the coolant channel, the ferrous material being inside at least a portion of the coolant channel or surrounding at least a portion of the coolant channel, and heating at least a portion of the battery cells of the battery system by inducing the eddy currents in the ferrous material through operating of the eddy current heater.

Further aspects of the present disclosure may be learned from the following description.

### BRIEF DESCRIPTION OF THE DRAWINGS

Aspects will become apparent to those of ordinary skill in the art by describing in detail embodiments with reference to the attached drawings in which:

FIG. 1 illustrates a schematic top view of a battery system according to one or more embodiments.

FIG. 2 illustrates an eddy current heater according to one or more embodiments.

FIG. 3 is a sectional view taken along the line A-A of FIG. 1.

FIG. 4 illustrates a schematic top view of a battery system according to one or more other embodiments.

FIG. 5 is a sectional view taken along the line B-B of FIG. 4.

FIG. 6 illustrates a schematic top view of coolant channel according to one or more other embodiments.

FIG. 7 is a sectional view taken along the line C-C of FIG. 6.

FIG. 8 illustrates a schematic top view of a battery system according to one or more other embodiments.

FIG. 9 is a sectional view taken along the line D-D of FIG. 8.

FIG. 10 illustrates a schematic top view of a battery system according to one or more other embodiments.

FIG. 11 is a sectional view taken along the line E-E of FIG. 10.

FIG. 12 illustrates a method of heating a plurality of battery cells of a battery system according to one or more embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that the present disclosure covers all modifications, equivalents, and replacements within the idea and technical scope of the present disclosure, that each of the features of embodiments of the present disclosure may be combined with each other, in part or in whole, and technically various interlocking and operating are possible, and that each embodiment may be implemented independently of each other, or may be implemented together in an association, unless otherwise stated or implied.

In the drawings, the relative sizes of elements, layers, and regions may be exaggerated for clarity and/or descriptive purposes. Further, the phrase “in a plan view” means when an object portion is viewed from above, and the phrase “in a schematic cross-sectional view” means when a schematic cross-section taken by vertically cutting an object portion is viewed from the side.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In one or more embodiments, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In one or more embodiments, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one aspect of the present disclosure, a battery system includes a plurality of battery cells accommodated in a housing. The battery system includes a cooling circuit or cooling system including a coolant channel, wherein the cooling circuit is configured to guide a coolant through the coolant channel. The coolant is in thermal contact with at least a portion of the plurality of battery cells while flowing through the coolant channel. The battery system may further include an eddy current heater including a ferrous material. The eddy current heater is configured to heat the ferrous material by inducing eddy currents in the ferrous material, and to transfer heat from the ferrous material to the coolant in the coolant channel. The ferrous material is positioned inside at least a portion of the coolant channel and/or surrounds at least a portion of the coolant channel.

The coolant channel may be referred to as a cooling pipe or a cooling tube. The coolant circuit may be referred to as a coolant system. The coolant circuit may include a pump to circulate the coolant along the coolant channel. The coolant may be a cooling liquid (e.g., a cooling water). The coolant liquid may have different levels of viscosity depending on the type of coolant used. A ferrous material may be a material primarily including iron. Ferrous materials may also include alloy steel, carbon steel, cast iron, wrought iron, etc., but the present disclosure is not restricted thereto. Alloying elements may include chromium, vanadium, nickel and/or manganese, but the present disclosure is not restricted thereto. The eddy current heater may generate a time-variant magnetic field that induces eddy currents in the ferrous material in response to the interaction of the magnetic field with the ferrous material.

By using an eddy current heater including the ferrous material for providing eddy currents to heat the battery cells, a rapid and efficient heating may be achieved. For example, the ferrous material and power lines providing the AC power for field-inducing the eddy currents in the ferrous material can be spatially separated from each other, so that the power lines are spatially separated from the coolant. In one or more embodiments, there may be little to no risk of bringing power lines into contact with the cooling liquid.

The positioning of the ferrous material with respect to the coolant channel has the following aspects. Because the ferrous material is not a section of the coolant channel (e.g., because the ferrous material is in the coolant channel, or surrounds the coolant channel), an improved leakage resistance may be achieved. For example, as compared to an example in which the ferrous material is a section of the coolant channel, additional seals may be suitable to connect the ferrous material part to the coolant channel part at the transitions therebetween. For example, the coolant channel may be made of aluminium, which is different from a ferrous material. However, due to thermal expansion of the ferrous material upon heating, such seals may be prone to leakage after a corresponding amount of time. Embodiments of the present disclosure may avoid this problem because the ferrous material is not a part of the coolant channel, but rather is placed inside the coolant channel, or placed to surround the coolant channel, so that the leakage properties of the coolant channel may remain unchanged.

Further, if the ferrous material is located inside the coolant channel, the heating distance to the coolant is reduced. That is, the heating effect is enhanced because the heating distance between a heat source (e.g., the ferrous material) and the coolant is reduced. In one or more embodiments, the coolant channel might not act as thermal barrier. Instead, if the ferrous material surrounds the coolant channel, the coolant flow in the coolant channel may remain unaltered, because there is no channel cross section reduction. In one or more embodiments, existing battery systems may be retrofittable by adding (e.g., by sleeving or coating) the ferrous material to the outer surface of the coolant channel.

According to one or more embodiments, the ferrous material may include an inner ferrous coating that is attached to at least a portion of an inner surface of the coolant channel. Using an inner ferrous coating may provide a very thin layer of ferrous material, so that the effective diameter or cross section of the coolant channel for transporting the coolant liquid is not excessively reduced. In one or more embodiments, the flow properties of the coolant may be less affected. This may be relevant if a very viscous coolant is used to reduce or prevent a (partial) clogging of coolant. As well, the heating distance (e.g., the distance between heat source and heat absorber (here coolant)) is reduced further enhancing the heating efficiency. Further, the risk of bringing power lines into contact with the cooling liquid may be reduced or eliminated.

According to one or more embodiments, the ferrous material may include at least an inner ferrous hollow body located inside the coolant channel to cover an inner surface of the coolant channel. Compared to the ferrous coating, an enhanced heating effect may be achieved, because more eddy currents may be induced in the hollow body material, and because higher thicknesses can be provided. That is, in a ferrous hollow body, the eddy current may be formed in a better manner, and heating due the enhanced eddy currents may be improved. The hollow body refers to a solid body as for example a cylinder or a ring/bracelet. As well, the heating distance (e.g., the distance between heat source and heat absorber (here coolant)) may be reduced, further enhancing the heating efficiency.

According to one or more embodiments, the inner ferrous hollow body may include at least one of an inner ring and/or an inner hollow cylinder. A ring may also be referred to as a bracelet. If using an inner ring, a local heating due to eddy currents formed in the ring may occur. Because a ring has no substantial extension in a lengthwise direction, local heating can be provided. For example, a ring may be useful if not much axial length can be provided. For example, a ring may be suitable if placing the ferrous material at a coolant inlet (or coolant outlet) of the housing for providing the heating at a location where the coolant enters the battery system, so that the coolant immediately has an increased temperature. A geometric cylinder allows for rapid heating in a region of a length (e.g., predetermined length) so that the heating interaction time may be enhanced, allowing for an improved heating effect.

According to one or more embodiments, the ferrous material may include a flat inner surface (e.g., a substantially even surface), which may have reduced flow resistance. For example, the coolant flow through the part including the ferrous material inside the coolant channel may have less flow resistance due to the even inner surface. This may be helpful if using a more viscous coolant liquid.

According to one or more embodiments, the ferrous material may include a corrugated inner surface configured to increase the surface area with the coolant. Due to the corrugated surface, the surface area of the ferrous material may be increased. This may provide a faster heat transferal due to an increased heat transfer area for a given length, which may be relevant for using an inner hollow cylinder.

According to one or more embodiments, the corrugated surface may include a plurality of ridges. The ridges may extend along the cooling cannel. The ridges may transfer heat resulting from the eddy currents to enhance heating transfer to the coolant. Such embodiments may be relevant for using an inner hollow cylinder. The ridges may be protrusions in other words.

According to one or more embodiments, the ferrous material may include an outer ferrous coating attached to at least a portion of an outer surface of the coolant channel. Such embodiments can be retrofitted in a suitable manner for already existing coolant channels because an external coating can be suitably added to an already existing coolant channel. Because the outer ferrous coating is not a section of the coolant channel, the coolant channel is maintained robust with respect to leakage. Further, the coolant flow in the coolant channel remains unaltered because there is no channel cross section reduction. In one or more embodiments, because the external coating can be provided to be very thin, the effective thickness of coolant channel together with outer ferrous coating is not very thick.

According to one or more embodiments, the ferrous material includes at least one outer ferrous hollow body surrounding at least a portion of the coolant channel to cover an outer surface of the coolant channel. Such embodiments can be suitably retrofitted on already existing coolant channels because the outer ferrous hollow body may be sleeved on the coolant channel (e.g., on a straight part of the coolant channel). Because the outer ferrous hollow body is not a section of the coolant channel, the coolant channel is maintained robust with respect to leakage. Further, the coolant flow in the coolant channel remains unaltered because there is no channel cross section reduction. In one or more embodiments, because the hollow body may host more eddy currents, good results for the heating efficiency may still be achieved to compensate for the coolant channel acting as thermal barrier. According to one or more embodiments the outer ferrous hollow body may include at least one of an outer ring and/or an outer hollow cylinder.

According to one or more embodiments, the ferrous material may be arranged at a coolant inlet for the coolant channel at the periphery of the housing and/or is extending from the coolant inlet along the coolant channel. In one or more embodiments, local eddy current heating can be provided at entry so that the coolant entering the battery system already has enhance temperature so that the majority of the plurality of battery cells including battery cells close to the coolant inlet can be pre-heated according to the methods disclosed herein.

According to one or more embodiments, the ferrous material may be arranged at a coolant outlet of the coolant channel at a periphery of the housing and/or may extend to the coolant outlet along the coolant channel. This may provide a redundancy if the eddy current heater at the coolant inlet stops working. In one or more embodiments, this positioning may allow reheating of coolant that was cooled down during transport along the coolant channel due to heat transfer.

According to one or more embodiments, the coolant channel may be made of a non-ferrous material. In one or more embodiments, the coolant channel can have improved material selection for the coolant transport without having to be modified for the eddy current heating. For example, the coolant channel may include aluminium tubes that are welded together to form the coolant channel.

According to one or more embodiments, the eddy current heater may include a heating coil and a charging circuit connected with the heating coil through AC power lines configured to provide AC power during operation to the heating coil to induce eddy currents in the ferrous material. The AC power in the coil may generate a time dependent magnetic field that interacts with the ferrous material to induce eddy currents in the ferrous material. A charging circuit may be referred to as a charger. An aspect is that existing onboard chargers (e.g., of a vehicle) can be used to provide the alternating currents. Alternatively, bespoke circuits can be provided instead of a charging circuit. Existing onboard chargers may be able to provide an AC power source. Because the chargers can work bidirectionally, the AC power lines can also be used if the charger is not plugged into an AC power grid.

According to one or more embodiments, the ferrous material may be insulated by a dielectric material. The dielectric material may be plastic. This may reduce or prevent a direct contact of the ferrous material, in which the eddy currents are formed with the coolant in the coolant channel. This may be useful for embodiments in which the ferrous material is placed inside the coolant channel.

According to one or more embodiments, the ferrous material is integrated within micro spheres dispersed in the coolant. The micro spheres may be surrounded by dielectric material (e.g., plastic). In one or more embodiments, the eddy current heating may be achieved directly in the coolant to effectively remove any heating distance. This may result in a more homogenous heating of the coolant (e.g., without having a heating profile across the coolant channel).

According to one or more other embodiments, a vehicle includes the battery system according to one of the above-described embodiments. The vehicle may have the same aspects as already described and mentioned above in the context of the battery system.

According to a method of heating a plurality of battery cells of a battery system, wherein the method includes the operations of a) providing a battery system. The method may include the operation of b) heating the plurality of battery cells by inducing eddy currents in the ferrous material through operation of the eddy current heater. The heating method may have the same aspects on the battery system as already described and mentioned above with respect to the battery system.

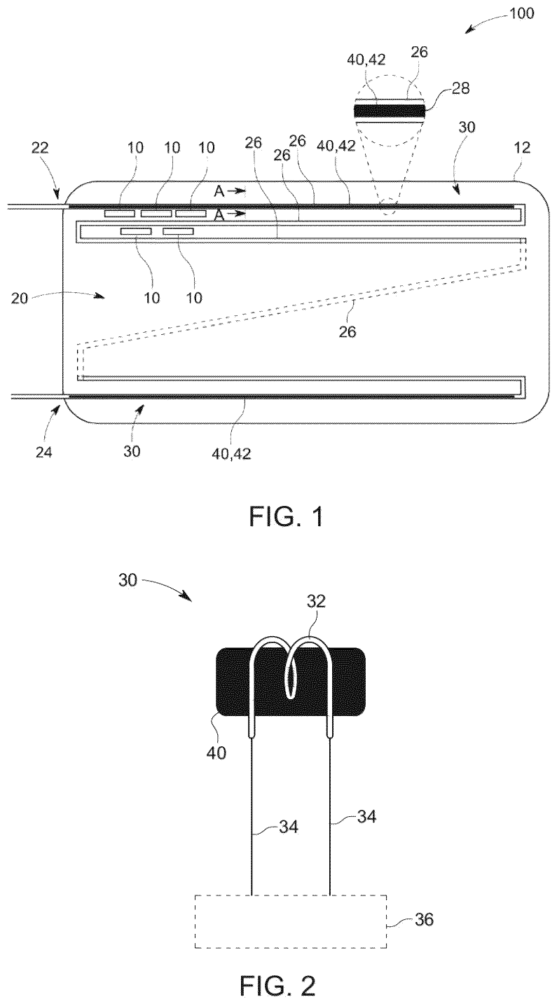

FIG. 1 is a top view illustrating a battery system 100 according to one or more embodiments of the present disclosure. The battery system 100 includes a plurality battery cells 10. The battery cells 10 are merely schematically shown for illustration of embodiments of the present disclosure. In one or more embodiments corresponding to FIG. 1, the battery cells 10 are prismatic battery cells 10 but the present disclosure is not restricted thereto. For example, spherical (or cylindrical) battery cells may be provided. The battery cells 10 may be interconnected with each other in a manner (e.g., predetermined manner) to provide a common output. The positioning of the battery cells 10 is not restricted to the positioning indicated in FIG. 1 but any other known positioning of battery cells 10 in a battery system 100 may be implemented.

The battery cells 10 may be accommodated in a housing 12. The housing 12 is schematically illustrated in this projection by a contour. The edges of the housing 12 are formed to be round, but this is merely for illustration, and the present disclosure is not restricted thereto. Other shapes of the housing 12 may be provided to form edges of the housing 12. In one or more embodiments, the housing 12 may include compartments in which the battery cells 10 are accommodated according to a positioning (e.g., predetermined positioning) to be (stably) supported in the housing 12.

The battery system 100 further includes a cooling circuit 20 (e.g., a cooling system). The cooling circuit 20 may include a coolant channel 26. The coolant channel 26 is schematically shown in FIG. 1 as being guided according to a pathway (e.g., predetermined pathway) through or along the housing 12. In one or more embodiments, the battery system 100 may include a cooling plate located below the battery cells 10 for cooling the battery cells 10. The coolant channel 26 may be provided in the cooling plate. However, the present disclosure is not restricted thereto and the coolant channel 26 may also be an individual channel passing at least a portion of the battery cells 10 accommodated in the housing 12. The coolant channel 26 (e.g., the dashed part of FIG. 1) may therefore have various pathways, and is not restricted to any particular pathway or route.

The cooling circuit 20 is configured to conduct a coolant through the coolant channel 26. The coolant (e.g., a coolant liquid) is caused to flow through the coolant channel 26. The coolant is thermally connected with at least a portion of the plurality of battery cells 10 in the housing 12. This means that an amount of heat energy can be exchanged between at least a portion of the battery cells 10 and the coolant which is transported through the coolant channel 26.

The coolant channel 26 transports or circulates the coolant being in thermal contact with at least a portion of the plurality of battery cells 10 while flowing through the coolant channel 26. The flow of the coolant caused by the cooling circuit 20 may be provided by a pump, in one or more embodiments. The pump may be controlled by corresponding control units for thermal management. Due to the thermal connecting of the coolant with the battery cells 10, controlling the temperature of the coolant allows adjustment of the temperature of the battery cells 10 due to being in thermal contact with the coolant transported in the coolant channel 26.

The coolant channel 26 may pass through the assembly of battery cells 10 to be in thermal contact with an increased portion of the battery cells 10. For example, the coolant channel 26 may meander between rows of battery cells 10. However, the present disclosure is not restricted thereto, and the form of the coolant channel 26 in the housing 12 may have a different coolant channel pathway therebetween. Further, the coolant channel 26 may include a coolant inlet 22 and a coolant outlet 24 wherein the coolant may flow to be transported between the coolant inlet 22 and the coolant outlet 24. The coolant inlet/outlet 22, 24 may be located at a periphery of the housing 12, which is schematically indicated in FIG. 1. The coolant channel 26 may include interconnected parts (e.g., a coolant channel network) between the coolant inlet 22 and the coolant outlet 24, and the present disclosure is not restricted to any particular coolant channel pathway. The coolant channel 26 may further be included in a coolant plate, or may be individually guided through the housing 12 without being part of a cooling plate.

The battery system 100 may further include an eddy current heater 30. The eddy current heater 30 includes a ferrous material 40. The ferrous material 40 may be configured and positioned according to various embodiments of the present disclosure as will be disclosed below.

The eddy current heater 30 is configured to heat the ferrous material 40 by inducing eddy currents in the ferrous material 40. In one or more embodiments, the material response of the ferrous material 40 capable of generating eddy currents is used by the eddy current heater 30. Therefore, the induced eddy currents then heat the material by Joule heating without a voltage being applied to the ferrous material 40. The heated ferrous material 40 can transfer heat to the coolant in the coolant channel 26, and the coolant may flow along the coolant channel 26 to transfer, by transport and by being thermal connected, the heat to at least a portion of the battery cells 10 of the battery system 100. The ferrous material 40 may further be insulated by a dielectric material (e.g., plastic), in one or more embodiments.

An example of an eddy current heater 30 is described with respect to FIG. 2. The eddy current heater 30 may include a heating coil 32 that is connected to AC power lines 34. An AC power source (e.g., a charging circuit 36) may be connected with the heating coil 32 through the AC power lines 34 to cause the heating coil 32 to induce eddy currents in the ferrous material 40 during operation. In detail, the heating coil 32 produces a varying magnetic field in response to the provided AC power. The varying magnetic field interacts with the ferrous material 40 to generate the eddy currents in the ferrous material 40 as a magnetic field response. The ferrous material 40 may be spatially distanced from the AC power lines 34 and/or the heating coil 32 such that field-induced eddy currents can be provided. The charging circuit may have the aspect that existing resources of the vehicle can be used. In alternatives, a bespoke circuit may be provided as an AC power source instead of the charging circuit 36.

All embodiments of the present disclosure have in common that the ferrous material 40 is located inside at least a portion of the coolant channel 26 and/or surrounds at least a portion of the coolant channel 26. This has the effect that the ferrous material 40 does not become a section of the coolant channel 26 resulting in an improved leakage robustness. This is because no additional seals are required to connect the ferrous material 40 to the coolant channel 26 at the transitions therebetween, which may lead to leakage over time due to repeated thermal expansion caused by heating. In one or more embodiments, the present disclosure may solve the leakage problem because the ferrous material 40 is not part of the coolant channel 26, but rather is placed inside the coolant channel 26 or surrounds it according to embodiments.

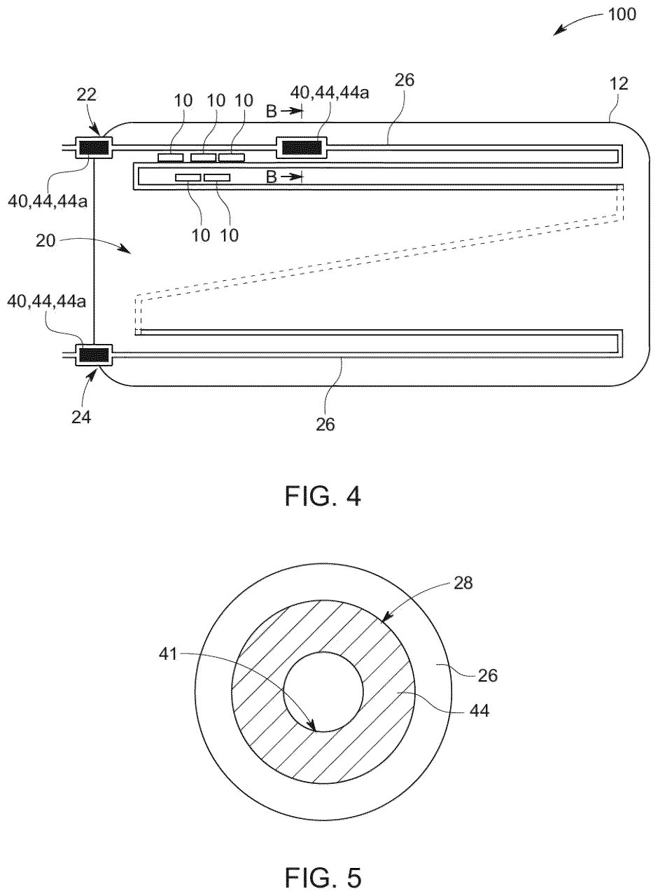

In accordance with FIG. 1, one or more embodiments are provided, which will be explained as follows. According to FIG. 1 (and also FIGS. 4 and 5), the ferrous material 40 is located inside at least a portion of the coolant channel 26. Because the ferrous material 40 is located inside the coolant channel 26, the heating distance between the ferrous material 40 and the coolant in the coolant channel 26 is reduced. In one or more embodiments, heating coupling between coolant and the ferrous material 40 is enhanced so that heating efficiency and speed is improved.

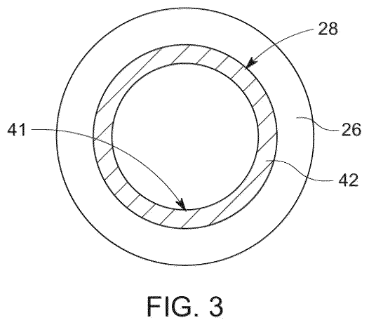

According to the one or more embodiments corresponding to FIG. 1, the ferrous material 40 includes an inner ferrous coating 42. The inner ferrous coating 42 is attached to at least a portion of an inner surface 28 of the coolant channel 26. This is illustrated in the one or more embodiments corresponding to FIG. 1, and is further illustrated in the cross section along the line A-A indicated in FIG. 1 and as shown in FIG. 3. Using an inner ferrous coating 42 allows a very thin layer of ferrous material, as can be seen in FIG. 3. The cross sections may be circular, but the present disclosure is not restricted thereto. In one or more embodiments, an effective inner diameter of the coolant channel 26 for transporting the coolant liquid is not significantly reduced so that coolant flowing through coolant channel 26 including the inner ferrous coating 42 is not strongly impacted by the inner ferrous coating 42.

Further, as indicated in the one or more embodiments corresponding to FIG. 3, the inner ferrous coating 42 may include a flat inner surface 41 so that an effect of reduced flow resistance is reached. This may be important if viscous coolant liquid is used to flow in the coolant channel 26.

For example, the inner ferrous coating 42 is extending from the coolant inlet 22 along the coolant channel 26. This is a suitable positioning because the coolant entering through the coolant inlet 22 is heated in the initial part so that the temperature of a total number of battery cells 10 in the battery system 100 can be increased or adjusted by being thermally connected with the heated coolant in the coolant channel 26. Because the inner ferrous coating 42 extends along the coolant channel 26, higher temperatures may be achieved in the coolant and in the battery cells 10 due to increased heating interaction length. This may compensate for the situation if the inner ferrous coating 42 is very thin so that the amount of heating per area may be limited.

However, the present disclosure is not restricted thereto, and local heating can also be provided (e.g., by allowing that the inner ferrous coating 42 to be arranged at a coolant inlet 22 for the coolant channel 26 at a periphery of the housing 12, which may be similar to the positioning in the one or more embodiments corresponding to FIG. 4). In one or more embodiments, a local heating is achieved upon the coolant entering the housing 12.

As shown in FIG. 1, the inner ferrous coating 42 is extending to the coolant outlet 24 along the coolant channel 26. This may imply a useful redundancy (e.g., if the eddy current heater at the coolant inlet 22 does not function). Further, this positioning may allow reheating of the coolant, which may have cooled down along the coolant path of the coolant channel 26 due to transferring heat to battery cells 10, so that battery cells 10 located in the final part close to the coolant outlet 24 of the housing 12 may also be exposed to heating.

However, the present disclosure is not restricted thereto, and local heating may also be provided, for example, by allowing that the inner ferrous coating 42 to be arranged at a coolant outlet 24 for the coolant channel 26 at a periphery of the housing 12 (for example similar to the positioning in the one or more embodiments corresponding to FIG. 4). It is emphasized that the positioning in FIG. 1 is only an example, and the inner ferrous coating 42 can also be formed along an entirety of the coolant channel 26. In other examples, the inner ferrous coating 42 may be located at corresponding segments of the coolant channel (e.g., according to predefined positions).

FIG. 4 is a top view illustrating a battery system 100 according to one or more other embodiments of the present disclosure. For the sake of conciseness, only the differences with respect to the one or more embodiments corresponding to FIG. 1 are described. For the features in common with FIG. 1, it is herewith referred to the above description. The one or more embodiments corresponding to FIG. 4 can be combined with the one or more embodiments corresponding to FIG. 1.

In the one or more embodiments corresponding to FIG. 4, the ferrous material 40 includes at least one inner ferrous hollow body 44 located inside the coolant channel 26 to cover an inner surface 28 of the coolant channel 26. An inner ferrous hollow body 44 may allow enhanced eddy current formation, as compared to a thin inner ferrous coating 42 of FIG. 1.

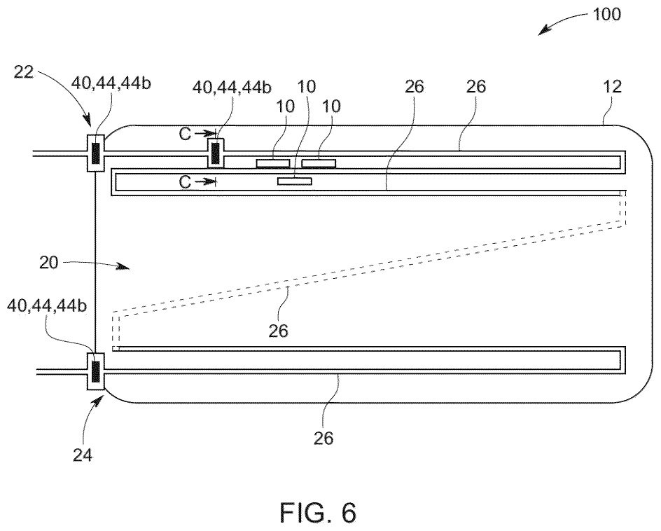

Also, the inner ferrous hollow body 44 may include a substantially flat inner surface 41, as shown in the cross section of FIG. 5, to reduce flow resistance. The cross sections may be circular, but the present disclosure is not restricted thereto. In embodiments, the coolant channel 26 may include a local widening section where the inner ferrous hollow body 44 is located (see FIG. 4) due to the thickness of the inner ferrous hollow body 44. In one or more embodiments, the inner channel diameter of coolant channel accessible for the coolant to flow through may be maintained also in this section where the inner ferrous hollow body 44 is located. This may apply as well to FIG. 6. Therefore, effective coolant flow may be maintained despite of the presence of the inner ferrous hollow body 44. However, in other embodiments, no widening portion is provided.

In the one or more embodiments corresponding to FIG. 4, the inner ferrous hollow body 44 includes an inner hollow cylinder 44a. The inner hollow cylinder 44a has a certain length in a channel direction, and thus can provide an increased amount of eddy current heating.

The inner hollow cylinder 44a may be arranged at a coolant inlet 22 for the coolant channel 26 at a periphery of the housing 12 as indicated in FIG. 4. This may result in providing improved heating coverage including the battery cells 10 positioned close to the coolant inlet 22. However, the present disclosure is not restricted thereto, and the inner hollow cylinder 44a may also be provided at different positions. For example, the inner hollow cylinder 44a may be arranged at a coolant outlet 24 for the coolant channel 26 at a periphery of the housing 12. In one or more embodiments, the inner hollow cylinder 44a may be arranged inside the housing 12 at a position(s) (e.g., predetermined position(s)).

FIG. 6 is a top view illustrating a battery system 100 according to one or more other embodiments of the present disclosure. For the sake of conciseness, only the differences with respect to the one or more embodiments corresponding to FIG. 4 are described. For the features in common with FIG. 4, it is herewith referred to the above description. The one or more embodiments corresponding to FIG. 6 can be combined with the one or more embodiments corresponding to FIGS. 1 and/or the one or more embodiments corresponding to FIG. 4.

In comparison to FIG. 4, the inner ferrous hollow body 44 includes an inner ring 44b. An inner ring 44b compared to a cylinder may allow local heating without taking up much length in direction of the coolant channel 26 (e.g., at the coolant inlet 22). This may be useful for positioning the inner ring 44b at the coolant inlet 22 and/or the coolant outlet 24.

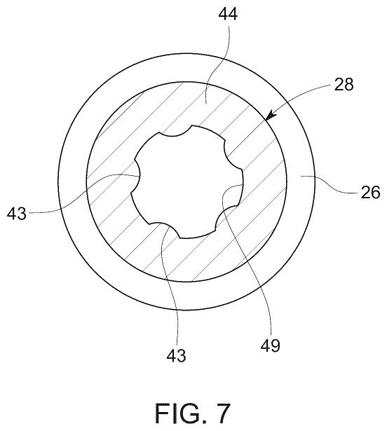

FIG. 7 shows a schematic cross section of a coolant channel 26 according to one or more other embodiments. The inner ferrous hollow body 44 includes a corrugated inner surface 49 configured to increase the surface area contact with the coolant. This has an effect of improving the heat exchange with the coolant. According to FIG. 7, the corrugated inner surface 49 includes a plurality of ridges 43. The ridges 43 may extend along the coolant channel 26. In one or more embodiments, the one or more embodiments corresponding to FIG. 7 may be compatible with the inner hollow cylinder 44. In one or more embodiments, heat transferal may be increased by modifying the inner surface of the inner ferrous hollow body 44.

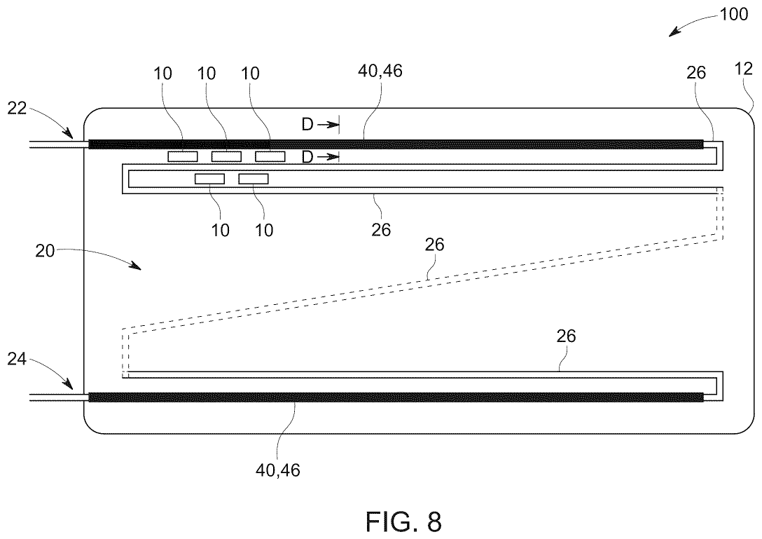

FIG. 8 is a top view illustrating a battery system 100 according to one or more other embodiments of the present disclosure. For the sake of conciseness, only the differences with respect to the one or more embodiments corresponding to FIG. 1 are described. For the features in common with FIG. 1, it is herewith referred to the above description. The one or more embodiments corresponding to FIG. 8 can be combined with the one or more embodiments corresponding to FIG. 1, the one or more embodiments corresponding to FIG. 4, and/or the one or more embodiments corresponding to FIG. 6.

In the one or more embodiments corresponding to FIG. 8, the ferrous material 40 includes an outer ferrous coating 46 attached to at least a portion of an outer surface 29 of the coolant channel 26. Such embodiments may allow improved retrofitting of already existing coolant channels because an external coating can be suitably added to a coolant channel 26. Further, any impact on the flow of the coolant in the coolant channel 26 is eliminated entirely.

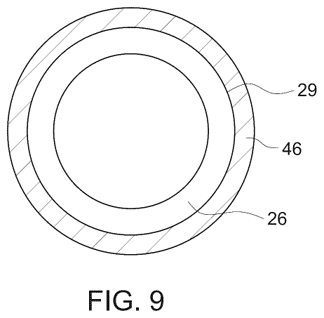

The one or more embodiments corresponding to FIG. 8 may have the same positioning of the outer ferrous coating 46 with respect to the coolant channel 26, apart from being on the outer surface 29 in contrast to FIG. 1. Any other positionings as described may also be used in the one or more embodiments corresponding to FIG. 8. A cross section of one or more embodiments corresponding to FIG. 8 is further provided in FIG. 9, indicating a thin outer ferrous coating 46. The cross sections may be circular, but the present disclosure is not restricted thereto. In one or more embodiments, the volume occupied by the by the coolant channel 26 having the outer ferrous coating 46 is not strongly increased.

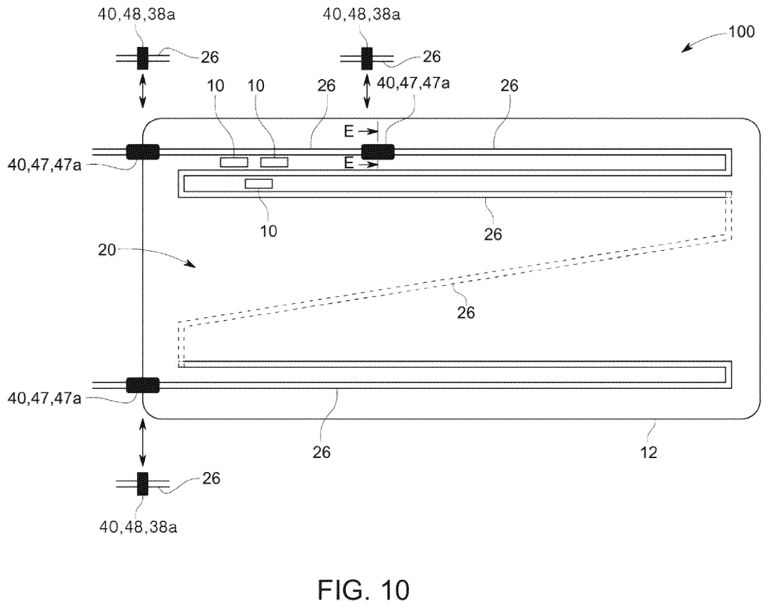

FIG. 10 is a top view illustrating a battery system 100 according to one or more other embodiments of the present disclosure. For the sake of conciseness, only the differences with respect to the embodiments of FIG. 4 or FIG. 6 are described. For the features in common with the embodiments of FIG. 4 and FIG. 6, it is herewith referred to the above description. Also, the combination of FIG. 10 and FIG. 4 or FIG. 6 or any other embodiments are included herein.

The ferrous material 40 in the one or more embodiments corresponding to FIG. 10 includes at least one outer ferrous hollow body 47, 48 surrounding at least a portion of the coolant channel 26 to cover an outer surface 29 of the coolant channel 26.

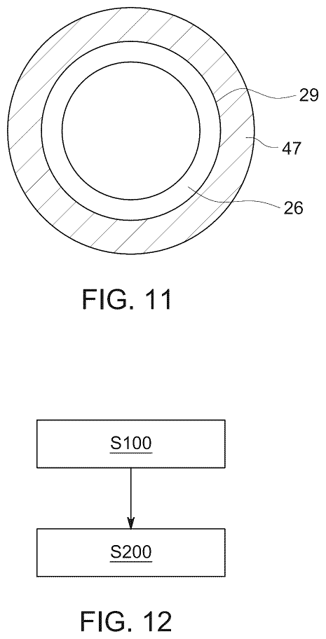

Therefore, the flow of the coolant is not affected by the outer ferrous hollow body 47, 48. Such one or more embodiments may be retrofitted by sleeving the outer ferrous hollow body 47, 48 on the coolant channel 26 (e.g., on a straight part of the coolant channel 26). In the one or more embodiments corresponding to FIG. 10, the outer ferrous hollow body 47, 48 may be an outer hollow cylinder 47a. However, as indicated in the FIG. 10, the outer hollow cylinder 47a may be replaced by an outer ring 48a. Also, combinations thereof can be provided. No additional seals are required in such embodiments because the coolant channel 26 is not affected by the outer ferrous hollow body 47, 48, and a coolant leakage problem may be reduced or eliminated. Cross sections for illustration of the outer ferrous hollow body 47, 48 are shown in FIG. 11. The cross sections may be circular, but the present disclosure is not restricted thereto. Because the outer ferrous hollow body 47, 48 may host more or larger eddy currents, good results for the heating efficiency may still be achieved to compensate for the coolant channel 26 acting as thermal barrier.

Any embodiments and positionings of the ferrous material 40 can be combined with each other to form new embodiments. For example, an inner ferrous coating 42 and outer ferrous coating 46 can be combined. In an example, both inner and outer surfaces 28, 29 of a portion of the coolant channel 26 may be covered by the inner ferrous coating 42 and the outer ferrous coating 46. This may increase the eddy current heating effect. For example, an inner ferrous hollow body 44 and outer ferrous hollow body 47, 48 may be combined. In an example, both inner and outer surfaces 28, 29 of a portion of the coolant channel 26 may be covered by the inner ferrous hollow body 44 and the outer ferrous hollow body 47, 48. This may increase the eddy current heating effect. However, the combinations are not restricted to the explicit embodiments as mentioned above.

FIG. 12 illustrates a method of heating a plurality of battery cells 10 of a battery system according to one or more embodiments described above. The method may include providing a battery system 100 (S100) as defined according to any of the above embodiments. The battery system 100 may be one among the embodiments as described in the above manner. The method further includes the operation of heating at least a portion of the plurality of battery cells 10 of the battery system 100 by inducing eddy currents in the ferrous material 40 through operating of the eddy current heater 30 (S200). Rapid and efficient heating may be provided by the heating method. The eddy current heater 30 may be configured according to the above-described embodiments.

In summary, provided is a battery system 100 with a coolant circuit and eddy current heater 30 including ferrous material 40 for allowing rapid and efficient heating without risk of bringing power lines into contact with the coolant. Further, various embodiments are provided in which the ferrous material 40 is not a section of the coolant channel 26 that results in improved leakage resistance. Various embodiments have a reduced heating distance and/or reduced flow resistance as detailed in the above disclosure in which further technical effects are described with more detail.

Reference signs

| | | | |
|---|---|---|---|
| 100 | battery system | 10 | battery cell |
| 12 | housing | 20 | cooling circuit |
| 22 | coolant inlet | 24 | coolant outlet |
| 26 | coolant channel | 28 | inner surface |
| 29 | outer surface | 30 | eddy current heater |
| 32 | heating coil | 34 | AC power line |
| 36 | charging circuit | 40 | ferrous material |
| 41 | flat inner surface | 42 | inner ferrous coating |
| 43 | ridge (heat exchanger) | 44 | inner ferrous hollow body |
| 44a | inner hollow cylinder | 44b | inner ring |
| 46 | outer ferrous coating | 47 | outer ferrous hollow body |
| 47a | outer hollow cylinder | 48 | outer ferrous hollow body |
| 48a | outer ring | 49 | corrugated inner surface |
| S100 | providing | S200 | heating |

What is claimed is:

1. A battery system comprising:
battery cells in a housing;
a cooling circuit comprising a coolant channel for allowing a coolant to flow therethrough to be in thermal contact with at least a portion of the battery cells;
an eddy current heater configured to heat a ferrous material by inducing eddy currents in the ferrous material, and to transfer heat to the coolant in the coolant channel, the ferrous material being inside at least a portion of the coolant channel or surrounding at least a portion of the coolant channel.

2. The battery system as claimed in claim 1, wherein the ferrous material comprises an inner ferrous coating attached to at least a portion of an inner surface of the coolant channel.

3. The battery system as claimed in claim 1, wherein the ferrous material comprises at least one inner ferrous hollow body inside the coolant channel to cover an inner surface of the coolant channel.

4. The battery system as claimed in claim 3, wherein the inner ferrous hollow body comprises at least one of an inner hollow cylinder and an inner ring.

5. The battery system as claimed in claim 2, wherein the ferrous material comprises a flat inner surface.

6. The battery system as claimed in claim 2, wherein the ferrous material comprises a corrugated inner surface.

7. The battery system as claimed in claim 6, wherein the corrugated inner surface comprises ridges.

8. The battery system as claimed in claim 1, wherein the ferrous material comprises an outer ferrous coating attached to at least a portion of an outer surface of the coolant channel.

9. The battery system as claimed in claim 1, wherein the ferrous material comprises at least one outer ferrous hollow body surrounding at least a portion of the coolant channel to cover an outer surface of the coolant channel.

10. The battery system as claimed in claim 1, wherein the ferrous material is at a coolant inlet of the coolant channel at a periphery of the housing, or extends from the coolant inlet along the coolant channel.

11. The battery system as claimed in claim 10, wherein the ferrous material is at a coolant outlet of the coolant channel at the periphery of the housing, or extends to the coolant outlet along the coolant channel.

12. The battery system as claimed in claim 1, wherein the coolant channel comprises a non-ferrous material.

13. The battery system as claimed in claim 1, wherein the eddy current heater comprises a heating coil, and a charging circuit connected with the heating coil through AC power lines for inducing the eddy currents in the ferrous material.

14. A vehicle comprising a battery system comprising:
battery cells in a housing;
a cooling circuit comprising a coolant channel for allowing a coolant to flow therethrough to be in thermal contact with at least a portion of the battery cells;
an eddy current heater configured to heat a ferrous material by inducing eddy currents in the ferrous material, and to transfer heat to the coolant in the coolant channel, the ferrous material being inside at least a portion of the coolant channel or surrounding at least a portion of the coolant channel.

15. A method of heating battery cells of a battery system, the method comprising:
providing the battery system, the battery system comprising:
battery cells in a housing;
a cooling circuit comprising a coolant channel for allowing a coolant to flow therethrough to be in thermal contact with at least a portion of the battery cells;
an eddy current heater configured to heat a ferrous material by inducing eddy currents in the ferrous material, and to transfer heat to the coolant in the coolant channel, the ferrous material being inside at least a portion of the coolant channel or surrounding at least a portion of the coolant channel; and
heating at least a portion of the battery cells of the battery system by inducing the eddy currents in the ferrous material through operating of the eddy current heater.
